(19) United States
(12) Patent Application Publication
(10) Pub. No.: US 2011/0202903 A1
(43) Pub. Date: Aug. 18, 2011

(54) APPARATUS AND METHOD FOR DEBUGGING A SHARED LIBRARY

(75) Inventors: Sang-Bae LEE, Seoul (KR); Sung-Do MOON, Seongnam-si (KR)

(73) Assignee: Samsung Electronics Co., Ltd., Suwon-si (KR)

(21) Appl. No.: 12/985,957

(22) Filed: Jan. 6, 2011

(30) Foreign Application Priority Data
Feb. 18, 2010 (KR) 10-2010-0014852

(51) Int. Cl. G06F 9/44

(52) U.S. Cl. 717/128

(57) ABSTRACT

An apparatus and method for debugging a shared library are provided. By performing the shared library-based debugging as described herein, instead of application process-based debugging, the limit of physical memory may be reduced and debugging efficiency may be improved by un-mapping a virtual map page in application processes that are mapped with the physical and logical memory addresses of the shared library.

### CROSS-REFERENCE TO RELATED APPLICATION(S)

This application claims the benefit under 35 U.S.C. §119(a) of Korean Patent Application No. 10-2010-0014852, filed on Feb. 18, 2010, in the Korean Intellectual Property Office, the entire disclosure of which is incorporated herein by reference for all purposes.

### BACKGROUND

1. Field

The following description relates to a debugging technique, and more particularly, to a technique of debugging a shared library that is capable of being executed by a plurality of application processes.

2. Description of the Related Art

is Recent electronic products are mostly designed based on hardware and software platforms. Middleware is generally required for the development of various application processes. The support of middleware as modules for software platforms may often need an excessive amount of memory especially when not using modules that perform the same functions as a shared library. This additional amount of memory often results in an increase in the price of electronic products.

Against this backdrop, the development of middleware and platforms using shared libraries has increased. The development of middleware and platforms using shared libraries is largely characterized by the use of software (particularly, middleware) that is not designed by the product developers. Because of this, debugging is often used to find and remove any bugs or malfunctions of the middleware.

However, conventional application process-based debugging may not be able to properly deal with various erroneous situations that may arise when a plurality of application processes access the same shared library.

### SUMMARY

In one general aspect, there is provided an apparatus for debugging a shared library, the apparatus comprising a memory monitoring unit configured to determine whether a shared library to be debugged has been loaded from a storage device into a volatile memory, and a debugging management unit configured to record information on the shared library if the results of the determination performed by the memory monitoring unit indicates that the shared library is yet to be loaded in the volatile memory, and to un-map a virtual map page for the shared library in all application processes if the results of the determination performed by the memory is monitoring unit indicates that the shared library is already loaded in the volatile memory.

If an application process attempts to execute the shared library, a debugging event may be generated.

The apparatus may further comprise a debugging unit configured to debug the shared library while keeping track of an operating state of one or more application processes executing the shared library, and configured to generate debugging information.

The apparatus may further comprise a debugging information output unit configured to output the debugging information.

The apparatus may further comprise an information input unit configured to receive information on the shared library from a user.

The apparatus may further comprise a debugging information output unit configured to output the debugging information, wherein the information input unit is configured to receive information on the application processes executing the shared library.

The memory monitoring unit may be further configured to determine whether the shared library has been loaded in the volatile memory by searching for a page table managed by a virtual memory manager of a kernel.

The debugging event may be generated when an application process attempts to execute the shared library.

If the shared library is loaded in the volatile memory, the debugging management unit may be further configured to change an instruction executed by the application process attempting to execute the shared library into a ‘Stop’ instruction and to enable the corresponding application process to be controlled by the debugging unit.

If the application process attempting to execute the shared library is determined as currently being debugged, the debugging unit may be further configured to output information is indicating that the corresponding application process has been terminated at a breakpoint.

If a user command to stop or resume the application process that has been terminated at the breakpoint is received, the debugging unit may be further configured to change the ‘Stop’ instruction into an original instruction that was executed by the corresponding application process.

If a software interrupt occurs due to the execution of the ‘Stop’ instruction, and if the application process attempting to execute the shared library is determined as currently not being debugged, the debugging unit may be further configured to output information indicating that the corresponding application process is attempting to execute the shared library.

The debugging unit may be further configured to perform post-analysis by monitoring the history of an arbitrary application process by monitoring the number of accesses made by the arbitrary application process to a code page of the shared library over an amount of time, and configured to analyze, based on the results of the monitoring, when and which part of the shared library has been executed by the arbitrary application process.

In another aspect, there is provided a method for debugging a shared library, the method comprising determining whether a shared library to be debugged has been loaded to memory, in response to the shared library not yet being loaded to memory, recording information about the shared library, and in response to the shared library being loaded to memory, un-mapping a virtual map page in one or more application processes that are mapped with the physical and logical memory addresses of the shared library.

The method may further comprise debugging the shared library while keeping track of an operating state of one or more application processes executing the shared library, and generating debugging information based on the debugging of the shared library.

The determining may further comprise determining whether the shared library has been loaded in volatile memory by searching for a page table managed by a virtual memory manager of a kernel.

In another aspect, there is provided a debugging apparatus for debugging a shared library, the debugging apparatus comprising a memory monitoring unit configured to determine whether the shared library has been loaded to memory, and a debugging management unit configured to record information about the shared library, if the memory monitoring unit determines that the shared library has not been loaded to the memory, and configured to un-map a virtual map page in one or more application processes that are mapped with the physical and logical memory addresses of the shared library, if the memory monitoring unit determines that the shared library has been loaded to the memory.

Other features and aspects may be apparent from the following description, the drawings, and the claims.

### BRIEF DESCRIPTION OF THE DRAWINGS

FIG. 1 is a diagram of an example apparatus for debugging a shared library.

FIG. 2 is a flowchart illustrating an example of a method for debugging a shared library.

Throughout the drawings and the description, unless otherwise described, the same drawing reference numerals should be understood to refer to the same elements, features, and structures. The relative size and depiction of these elements may be exaggerated for clarity, illustration, and convenience.

### DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

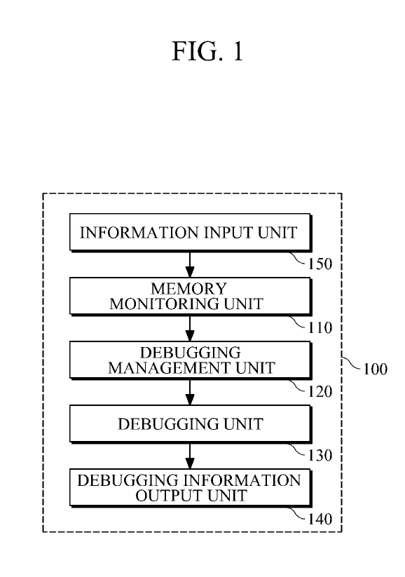

FIG. 1 illustrates an example of an apparatus for debugging a shared library. Referring to FIG. 1, apparatus 100 includes a memory monitoring unit 110, a debugging management unit 120, and a debugging unit 130. The apparatus 100 may also include a debugging information output unit 140 and/or an information input unit 150.

The memory monitoring unit 110 may determine whether a shared library to be debugged has been loaded, for example, from a storage device. As a non-exhaustive illustration only, the storage device may be, for example, a hard disk drive (HDD), a flash memory, a nonvolatile memory such as an electrically erasable programmable read-only memory (EEPROM), a volatile memory such as a random access memory (RAM), and the like. The memory monitoring unit 110 may determine whether the shared library has been loaded in the volatile memory. For example, the memory monitoring unit 110 may search for a page table managed by a virtual memory manager supported by an operating system (OS) kernel. A request for the shared library to be loaded may be made by, for example, a user, a program, automatically, and the like.

If the shared library is yet to be loaded in the volatile memory, the debugging management unit 120 may record information on the shared library that is to be debugged. Alternatively, if the shared library has been loaded in the volatile memory, the debugging management unit 120 may un-map a virtual map page for the shared library in all application processes.

For example, if the shared library is yet to be loaded in the volatile memory, the debugging management unit 120 may record the information on the shared library and may get ready for a later debugging of the shared library. For example, the shared library may be debugged when the shared library is loaded in the volatile memory.

As another example, if the shared library has already been loaded in the volatile memory, the debugging management unit 120 may un-map a virtual map page in all application processes that maps the physical and logical memory addresses of the shared library. That is, the debugging management unit 120 may un-map the virtual map page in one or more application processes, for example, every application process that is mapped to the physical and logical memory addresses of the shared library. Accordingly, the debugging management unit 120 may reduce the limit of physical memory on the debugging of the shared library.

If an application process attempts to execute the shared library, a general central processing unit (CPU) memory management unit (MMU) may generate a debugging event, such as a page fault exception.

For example, a page fault exception may occur when an application process attempts to execute the shared library and the virtual map page for the shared library is un-mapped. If a page fault exception occurs, the general CPU MMU may generate a debugging event that gives instructions to debug the shared library.

The debugging unit 130 may debug the shared library while keeping track of the operating status of one or more application processes executing the shared library. Then, the debugging unit 130 may generate debugging information.

As described herein, the apparatus 100 may reduce the limit of physical memory and may improve debugging efficiency by un-mapping the virtual map page in all application processes that maps the physical and logical memory addresses of the shared library.

The apparatus 100 may also include a debugging information output unit 140. For example, the debugging information output unit 140 may output the debugging information provided by the debugging unit 130. For example, the debugging information output unit 140 may be an output interface for outputting text-based and/or graphic-based debugging information to a user through a display device.

As another example, the apparatus 100 may include an information input unit 150. The information input unit 150 may receive information on the shared library from the user. The information input unit 150 may receive information on one or more application processes executing the shared library.

For example, the information input unit 150 may be an input interface receiving an identifier of the shared library and/or the file names of one or more application processes executing the shared library from the user.

The apparatus 100 may guarantee a stable debugging of the shared library by alerting an application process to a software interrupt that is generated during the execution of the shared library so as to prevent the application process from being terminated abnormally.

For example, if the shared library is loaded in the volatile memory, the debugging management unit 120 may change the instruction executed by an application process attempting to execute the shared library into a ‘Stop’ instruction and may enable the application process to be controlled by the debugging unit 130. If the application process executes the ‘Stop’ instruction a software interrupt occurs. Accordingly, if the application process is determined as currently being debugged, the debugging unit 130 may output information indicating that the application process has been terminated at a breakpoint. In the alternative, if the application process is determined as not being debugged, the debugging unit 130 may output information indicating that the application process is attempting to execute the shared library.

If a user command to stop or resume the application process that was terminated at the breakpoint is received, the debugging unit 130 may change the ‘Stop’ instruction into the original instruction executed by the application process and may allow the application process to execute the shared library.

The debugging unit 130 may perform post-analysis by monitoring the history of one or more application processes. For example, the debugging unit 130 may monitor an arbitrary application process to determine how many accesses to a code page of the shared library the arbitrary application process attempts for any given amount of time. Based on the results of the monitoring, the debugging unit 130 may analyze when and which part of the shared library has been executed by the arbitrary application process.

Accordingly, the apparatus 100 may provide the same functions provided by an application process-based debugging method, for example, ‘Breakpoint,’ ‘Stop tracing,’ and ‘Post-analysis’ functions.

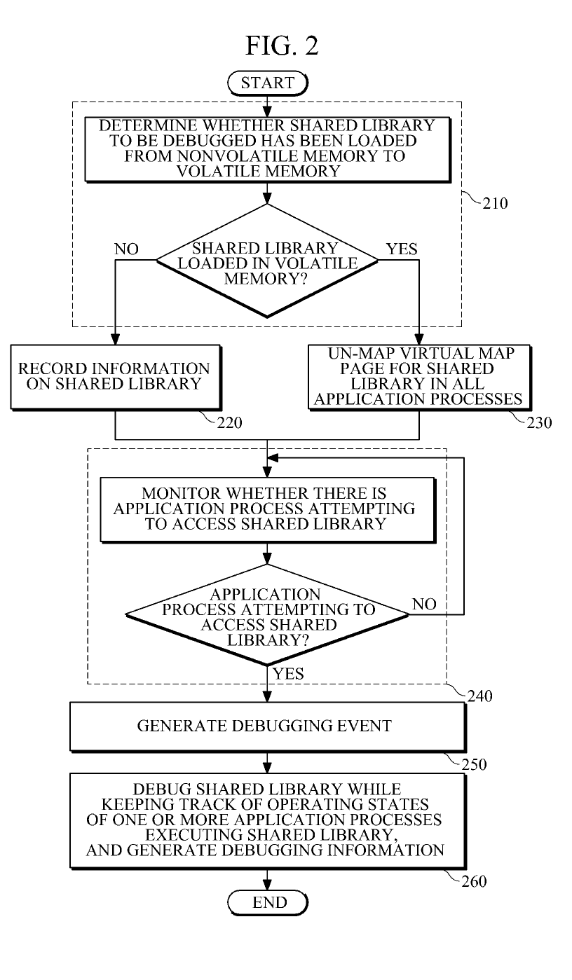

The operation of an apparatus for debugging is described with reference to FIG. 2.

FIG. 2 illustrates an example of a method for debugging a shared library. Referring to FIG. 2, in 210 the apparatus may determine whether a shared library to be debugged has been loaded, for example, loaded from a storage device such as an HDD, a flash memory, a nonvolatile memory such as an EEPROM, and the like. As another example, the shared library may be loaded to a volatile memory such as a RAM or may be waiting to be loaded, in 210.

For example, the apparatus may determine whether the shared library has been loaded in the volatile memory by searching for a page table managed by a virtual memory manager supported by an OS kernel.

If it is determined in 210 that the shared library is yet to be loaded in the volatile memory, in 220 the apparatus may record information on the shared library and/or about the shared library and may get ready for a later debugging of the shared library. The debugging may be performed when the shared library is loaded in the volatile memory.

Alternatively, if it is determined in 210 that the shared library is already loaded in the volatile memory, in 230 the apparatus may un-map a virtual map page in one or more application processes, for example, all application processes that maps the physical and logical memory addresses of the shared library. Accordingly, the method may reduce the limit of physical memory on a later debugging of the shared library.

In 240, the apparatus may determine whether there is an application process attempting to execute the shared library. If it is determined in 240 that there is an application process attempting to execute the shared library, in 250, a debugging event such as a page fault exception may be generated. For example, a page fault exception may occur when an application process attempts to execute the shared library when the virtual map page for the shared library is un-mapped. Accordingly, if a page fault exception occurs, the debugging event that gives instructions to debug the shared library may be generated.

In 260, the apparatus may debug the shared library while keeping track of the operating status of one or more application processes executing the shared library. In addition, in 260 the debugging unit 130 may generate debugging information.

As described herein, the apparatus and method may reduce the limit of physical memory and may improve debugging efficiency by un-mapping a virtual map page in all application processes that maps the physical and logical memory addresses of a shared library to be debugged.

The processes, functions, methods, and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for debugging a shared library, the apparatus comprising:
a memory monitoring unit configured to determine whether a shared library to be debugged has been loaded from a storage device into a volatile memory; and
a debugging management unit configured to record information on the shared library if the results of the determination performed by the memory monitoring unit indicates that the shared library is yet to be loaded in the volatile memory, and to un-map a virtual map page for the shared library in all application processes if the results of the determination performed by the memory monitoring unit indicates that the shared library is already loaded in the volatile memory.

2. The apparatus of claim 1, wherein, if an application process attempts to execute the shared library, a debugging event is generated.

3. The apparatus of claim 2, further comprising a debugging unit configured to debug the shared library while keeping track of an operating state of one or more application processes executing the shared library, and configured to generate debugging information.

4. The apparatus of claim 3, further comprising a debugging information output unit configured to output the debugging information.

5. The apparatus of claim 1, further comprising an information input unit configured to receive information on the shared library from a user.

6. The apparatus of claim 3, further comprising a debugging information output unit configured to output the debugging information and the information input unit is configured to receive information on the application processes executing the shared library.

7. The apparatus of claim 1, wherein the memory monitoring unit is further configured to determine whether the shared library has been loaded in the volatile memory by searching for a page table managed by a virtual memory manager of a kernel.

8. The apparatus of claim 3, wherein the debugging event is generated when an application process attempts to execute the shared library.

9. The apparatus of claim 8, wherein, if the shared library is loaded in the volatile memory, the debugging management unit is further configured to change an instruction executed by the application process attempting to execute the shared library into a ‘Stop’ instruction and to enable the corresponding application process to be controlled by the debugging unit.

10. The apparatus of claim 9, wherein, if the application process attempting to execute the shared library is determined as currently being debugged, the debugging unit is further configured to output information indicating that the corresponding application process has been terminated at a breakpoint.

11. The apparatus of claim 10, wherein, if a user command to stop or resume the application process that has been terminated at the breakpoint is received, the debugging unit is further configured to change the ‘Stop’ instruction into an original instruction that was executed by the corresponding application process.

12. The apparatus of claim 9, wherein, if a software interrupt occurs due to the execution of the ‘Stop’ instruction, and if the application process attempting to execute the shared library is determined as currently not being debugged, the debugging unit is further configured to output information indicating that the corresponding application process is attempting to execute the shared library.

13. The apparatus of claim 11, wherein the debugging unit is further configured to perform post-analysis by monitoring the history of an arbitrary application process by monitoring the number of accesses made by the arbitrary application process to a code page of the shared library over an amount of time, and configured to analyze, based on the results of the monitoring, when and which part of the shared library has been executed by the arbitrary application process.

14. A method for debugging a shared library, the method comprising:
determining whether a shared library to be debugged has been loaded to memory;
in response to the shared library not yet being loaded to memory, recording information about the shared library; and
in response to the shared library being loaded to memory, un-mapping a virtual map page in one or more application processes that are mapped with the physical and logical memory addresses of the shared library.

15. The method of claim 14, further comprising:
debugging the shared library while keeping track of an operating state of one or more application processes executing the shared library; and
generating debugging information based on the debugging of the shared library.

16. The method of claim 14, wherein the determining further comprises determining whether the shared library has been loaded in volatile memory by searching for a page table managed by a virtual memory manager of a kernel.

17. A debugging apparatus for debugging a shared library, the debugging apparatus comprising:
a memory monitoring unit configured to determine whether the shared library has been loaded to memory; and
a debugging management unit configured to record information about the shared library, if the memory monitoring unit determines that the shared library has not been loaded to the memory, and configured to un-map a virtual map page in one or more application processes that are mapped with the physical and logical memory addresses of the shared library, if the memory monitoring unit determines that the shared library has been loaded to the memory.
